(19) United States
(12) Patent Application Publication
(10) Pub. No.: US 2025/0130926 A1
(43) Pub. Date: Apr. 24, 2025

(54) METHOD AND SYSTEM FOR GENERATING CODE FOR A MOBILE COMMUNICATION TESTER

(71) Applicant: Rohde & Schwarz GmbH & Co. KG, Munich (DE)

(72) Inventors: Tobias WINKLER, Munich (DE); Sami IBISHI, Stuttgart (DE)

(21) Appl. No.: 18/382,347

(22) Filed: Oct. 20, 2023

(51) Int. Cl. G06F 11/36

(52) U.S. Cl. CPC G06F 11/3684

(57) ABSTRACT

The present disclosure relates to a method for generating code for a mobile communication tester. The method comprises the steps of: receiving information on a test scenario at an inputting environment; and automatically generating a test script code for the mobile communication tester based on the received information; wherein the test script code is configured in such a way that, when it is executed by the mobile communication tester, it causes the mobile communication tester to generate a test routine according to the test scenario, wherein the test routine adheres to a mobile communication standard.

### TECHNICAL FIELD

The present disclosure relates to a method and a system for generating code, in particular test script code, for a mobile communication tester.

### BACKGROUND ART

Mobile communication testers are essential tools used in the field of wireless communication to evaluate the proper functioning of wireless devices and systems. They can be used during the development, manufacturing, installation, and maintenance of wireless communication technologies.

Mobile communication testers often cover a multitude of different wireless technologies and protocols. For instance, they can carry out complex tasks such as protocol testing and scripted callbox testing.

The number of features and configuration possibilities provided by mobile communication testers can be extensive. A user of a mobile communication tester who wants to carry out tests in an automated way needs to be knowledgeable in terms of the communication protocols in which the tests are to be carried out, as well as in the specific automation environment of the tester, e.g., the programming language of the tester. Often, the coding language and/or the commands to be used are device and/or manufacturer specific.

The current approach for overcoming this issue is to provide the user with sufficient documentation, tutorials, and in-person training (e.g., workshops) to operate on his own. However, this is often not sufficient to compensate for the lack of thorough understanding of programming paradigms, automation environment, and the comprehension on how to translate the specification of communication protocols to code.

Hence, there is often a need for additional on-site support from support personnel, e.g., application engineers. For instance, the support personnel provides the user with a tailored and customizable script which the user can adapt to his requirements at a later time. However, this extensive personal support can be expensive in terms of time and resources.

### SUMMARY

Thus, there is a need to provide an improved method and an improved system for generating code for a mobile communication tester which avoid the above-mentioned disadvantages.

These and other objectives are achieved by the embodiments provided in the enclosed independent claims. Advantageous implementations of the embodiments of the present disclosure are further defined in the dependent claims.

According to a first aspect, the present disclosure relates to a method for generating code for a mobile communication tester, comprising the steps of: receiving information on a test scenario at an inputting environment; and automatically generating a test script code for the mobile communication tester based on the received information; wherein the test script code is configured in such a way that, when it is executed by the mobile communication tester, it causes the mobile communication tester to generate a test routine according to the test scenario, wherein the test routine adheres to a mobile communication standard.

This achieves the advantage that the overall expenses of resources (such as support by application engineers, training etc.) for generating the test script code can be reduced. Hereby, automatically generating the test script code means that the code is not manually written and/or customized by a user, but fully generated by a processing unit. This can greatly increase the speed at which new automated tests can be generated and carried out.

The mobile communication tester can be a radio communication tester. The mobile communication tester can be connected to one or more communication devices to be tested (DUTs) via wireless or wirebound connections.

The test scenario can define the test routine for testing one or more DUTs in terms of any combination of the following parameters: a type of test to be carried out, the type of DUT(s), a cabling used to connect the DUT(s) with the mobile communication tester, a communication scenario (e.g., a sequence of signals to be exchanged between tester and DUT), a communication standard to be used, a testing environment, a number of cells (e.g., according to 4G, 5G or 6G).

For instance, adhering to a mobile communication standard means that the test routine is carried out using valid parameters of cells, valid configurations and/or valid procedures according to the communication standard.

The inputting environment can be a communication interface which is configured to receive the information, e.g. in text form. For instance, the inputting environment can be incorporated in an IDE (integrated development environment) plugin.

In an implementation form of the first aspect, the test routine comprises a generation and/or a reception of at least one communication signal by the mobile communication tester, wherein the at least one communication signal adheres to the mobile communication standard.

The test routine can comprise additional steps besides signal generation and receipt.

In an implementation form of the first aspect, the mobile communication standard is a 3GPP based standard. For instance, the mobile communication standard can be a 4G (e.g. LTE), 5G or 6G standard.

In an implementation form of the first aspect, the information on the test scenario is received at the inputting environment in a plain language format.

For instance, the information can be received in the form of a text file or text input which contains the information in plain language (i.e., natural language). The information can further be received in form of a prompt or comment in plain language.

In an implementation form of the first aspect, the test script code is generated in Python or a Python based programming language. In this way, the test script code is executable by a mobile communication tester which is configured to be controlled via commands/prompts in a Python programming language.

Preferably, the test script code is generated in a suitable programming language and/or in form of a suitable command set for controlling and/or adapting the mobile communication tester. For instance, the test script code comprises commands for controlling the mobile communication tester which are generated according to SCPI (Standard Commands for Programmable Instruments).

The test script code can further adhere to a device specific scripting interface of the mobile communication tester, such as R&S® XLAPI or R&S® CMSequencer, and/or to a device specific code base. For instance, R&S® XLAPI is a Python interface of the mobile communication tester, R&S® CMsequencer is a graphical scripting interface that creates, configures and executes test scripts, and code base is an executable code by the mobile communication tester.

In an implementation form of the first aspect, the method comprises the further step of: outputting the generated test script code.

The test script code can be outputted in a way which allows transferring it to the mobile communication tester. For example, the test script code could be outputted to a communication network.

In an implementation form of the first aspect, the method comprises the further step of: preprocessing and/or postprocessing the test script code.

Preprocessing can generally refer to any action which bring the received information on the test scenario in a format which improves the quality of the output. For instance, during preprocessing, language prompts containing the information on the test scenario can be verified and/or their compatibility with the code generation method (e.g., an LLM) can be ensured. During postprocessing, the test script code can be further improved, e.g. by applying a code checker and/or carrying out a syntax checking.

In an implementation form of the first aspect, the test script code is generated by a trainable large language model (LLM).

In an implementation form of the first aspect, the large language model is trained by training data, wherein the training data comprises any combination of: instrument documentation of the mobile communication tester, information on communication standards, information on communication devices-under-test, test specifications, and previously generated test script code. In particular, the training data can be instrument-specific data of the mobile communication tester.

The LLM can be trained for specific targets or goals. For instance, the LLM is trained to fine-tune the test script code to specific boundaries.

In an implementation form of the first aspect, the method comprises the further step of: receiving a query on the generated test script code; wherein the large language model is configured to provide information on the test script code based on the query. For instance, the LLM can generate and output the information to the user that made the query.

The large language model can implement an AI application, such as a chatbot, which is configured to receive the query and generate the information based on the query: The information can thereby be provided at least partially in plain language. For instance, the information can comprise code explanations (e.g., explaining the function of code snippets in plain language), information for debugging the test script code, and/or information for code optimization.

Furthermore, the chatbot can assist the automation of the generation of test scenarios based on the provided specifications. The recommendations of the chatbot can thereby become increasingly context sensitive as it learns from user interactions and feedback.

In an implementation form of the first aspect, the method comprises the further step of: executing the test script code with the mobile communication tester to generate the test routine according to the test scenario.

According to a second aspect, the present disclosure relates to a system for generating code for a mobile communication tester, comprising: an inputting environment configured to receive information on a test scenario; and a processor configured to automatically generate a test script code for the mobile communication tester based on the received information, wherein the test script code is configured in such a way that, when it is executed by the mobile communication tester, it causes the mobile communication tester to generate a test routine according to the test scenario, wherein the test routine adheres to a mobile communication standard.

The inputting environment can be a communication interface which is configured to receive the information, e.g. in text form. For instance, the inputting environment can be incorporated in an IDE (integrated development environment) plugin.

In an implementation form of the second aspect, the system further comprises an interface configured to output the generated test script code.

The interface can be a communication interface, e.g. a USB or Ethernet interface. The interface can directly or indirectly be connected to the mobile communication tester.

In an implementation form of the second aspect, the processor is configured to preprocess and/or to postprocess the test script code.

In an implementation form of the second aspect, the processor is configured to execute a trainable large language model which generates the test script code.

### BRIEF DESCRIPTION OF THE DRAWINGS

The above described aspects and implementation forms of the present disclosure will be explained in the following description of specific embodiments in relation to the enclosed drawings, in which:

FIG. 1 shows a flow chart of a method for generating code for a mobile communication tester according to an embodiment;

FIG. 2 shows a flow chart of a method for generating code for a mobile communication tester according to an embodiment; and

FIG. 3 shows a schematic diagram of a system for generating code for a mobile communication tester according to an embodiment.

### DETAILED DESCRIPTIONS OF EMBODIMENTS

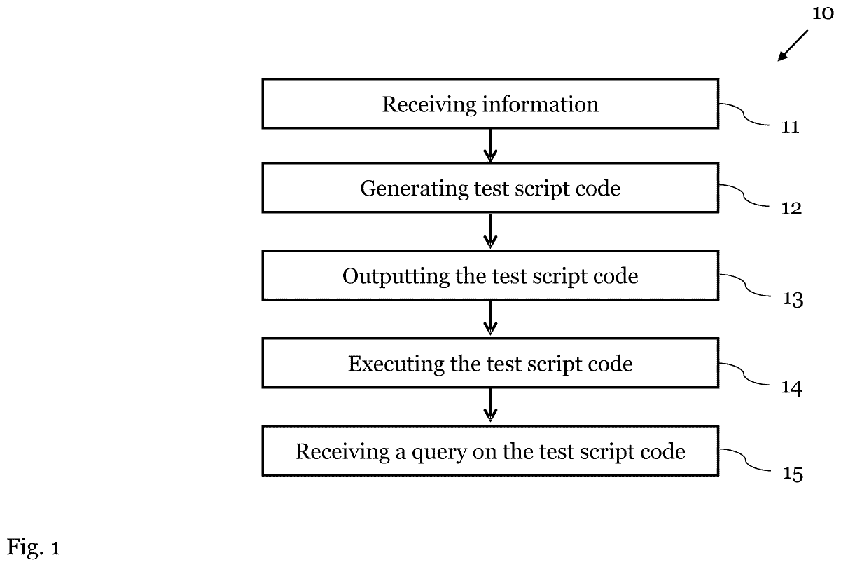

FIG. 1 shows a flow chart of a method 10 for generating code for a mobile communication tester according to an embodiment.

The method 10 comprises: receiving 11 information on a test scenario at an inputting environment; and automatically generating 12 a test script code for the mobile communication tester based on the received information; wherein the test script code is configured in such a way that, when it is executed by the mobile communication tester, it causes the mobile communication tester to generate a test routine according to the test scenario, wherein the test routine adheres to a mobile communication standard.

The mobile communication tester can be connected to one or more communication devices to be tested (DUTs), e.g., via wireless or wirebound connections. The mobile communication tester can be configured to carry out protocol testing and/or scripted callbox testing.

The mobile communication standard can be a 3GPP based standard, such as 4G, 5G or 6G.

The test scenario can define the test routine for testing one or more DUTs in terms of any combination of the following parameters: the type of DUT(s), a cabling used to connect the DUT(s) with the mobile communication tester, a communication scenario, a communication standard, a communication environment, a number of cells (e.g., according to 4G, 5G or 6G).

The test routine can comprise a generation and/or a reception of at least one communication signal by the mobile communication tester based on the desired test scenario, wherein the at least one communication signal adheres to the mobile communication standard, e.g. in terms of valid parameters of cells, valid configurations and/or valid procedures according to the communication standard.

The test script code can be a code which controls the mobile communication device to carry out the test routine. E.g., the test script code can be a protocol test code. Therefore, the test script code can automatically be generated in a programming language and/or using control commands or prompts which are suitable for the mobile communication tester. For instance, the test script code is generated in Python or a Python based programming language and/or according to a device specific scripting language and/or command format (such as SCPI).

The test script code can be generated by a large language model (LLM), such as ChatGPT, LLaMA, Orca or a comparable LLM. The LLM can be a deep learning model.

For instance, the information on the test scenario can be received at the inputting environment in a plain language format (e.g., in form of a prompt or a comment).

The LLM can be configured to translate this plain language input into the test script code by utilizing the context of: the communication protocol, further specifications (e.g., device and/or test specific information) and/or an internal code base.

The LLM could be provided as a plug-in directly in an IDE (integrated development environment) of a user of the mobile communication tester.

Using an LLM to convert natural language (i.e., plain language) commands to test script code provides several benefits for the user of the mobile communication tester: (i) it speeds up the implementation of new tests as the process of script generation can be automated; (ii) it reduces the overall expenses of resources (e.g., support personnel, workshops, etc.); and (iii) it optimizes the overall user experience for using/adapting the mobile communication tester.

The method 10 may comprise the further step of outputting 13 the test script code. The test script code can be outputted via a communication interface which can directly or indirectly be connected to the mobile communication tester. In this way, the test script code can be transferred to the mobile communication tester.

Furthermore, the method 10 may comprise the step of executing 14 the text script code with the mobile communication tester to generate the test routing according to the test scenario.

In a further optional step, the method 10 can comprise: receiving 15 a query on the generated test script code or on test script code to be generated by the LLM, wherein the LLM is configured to generate and output information based on the query.

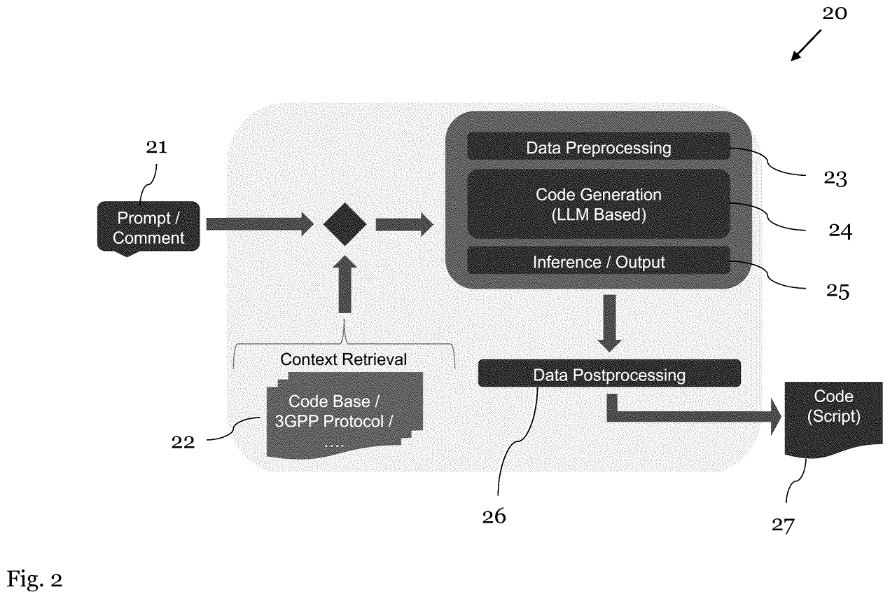

FIG. 2 shows a flow chart of a method 20 for generating the test script code according to an embodiment. The method 20 shown in FIG. 2 can thereby correspond to the method 10 shown in FIG. 1, wherein an LLM is executed to generate the test script code. In particular, the method 20 shown in FIG. 2 can comprise some or all the steps of the method 10 shown in FIG. 1.

The method 20 can be used for code generation in a specific domain. It can automate the generation of test scripts in a suitable programming language (e.g., Python) for the mobile communication tester based on plain language inputs that do not require deeper knowledge of the automation environment of the mobile communication tester.

The method 20 can be based on extending and fine-tuning LLMs and on designing a target specific deep learning architecture. For this purpose, data is utilized that creates the context to the prompts containing a code base of the communication tester, communication protocols/specifications (3GPP), tutorials, as well as documentations of the code base and the mobile communication tester. This data can also represent trainings data for training the LLM.

The method 20 can be used to convert (or translate) plain language prompts into code, e.g., Python scripts. However, it can also convert the prompts into control commands, e.g. SCPI commands or CMSequencer blocks. This can be implemented in a large deep learning model with multiple outputs (in different formats). An alternative could be to have multiple LLM models in parallel and then select the desired target output either manually or through automated evaluation of the prompts.

Before carrying out the method 20, as e.g. shown in FIG. 2, the LLM is generated and/or trained using various training data.

In general, the training data can comprise any combination of: instrument documentation of the mobile communication tester, information on communication standards, test specifications, and previously generated test script code.

For instance, to develop/train the code generation application (i.e., the LLM), primary training data is first gathered and prepared for training. This primary training data can comprise company-specific source code(s), tutorials, documentation, etc. These resources can be collected and preprocessed to extract relevant code snippets, comments, and specifications. The comments containing the specifications can then be paired with the corresponding code snippets.

For example, the training data can comprise raw data, such as:
XLAPI and instrument documentation
Information on communication standards (e.g., 3GPP protocols/specifications)
XLAPI Code Base
   XLAPI FW
   XLAPI Client (KF-Packages+Notebooks)
[Optional] Python Test Case Codebase (from internal test teams, application engineering teams, etc.)

This raw training data can be preprocessed and paired with comments, which represent the input prompts with test specifications from a user, and then fed to the LLM for training purposes.

The output/labels generated by the LLM from the above training data can comprise code in the following formats/specifications:
XLAPI/Pyhton
SCPI commands
CMSequencer blocks

The trained LLM can then be used to generate the test script code using the steps of the method 20 shown in FIG. 2. First, input prompts can be received 21 in form of comments containing specifications in plain language. Moreover, further context information can be retrieved 22, e.g. information on the 3GPP protocol to use or the relevant code base. This information can be retrieved automatically or can be input by the user. The input prompts (e.g., comments) and/or the further context information can define the test scenario for which the test script code is to be generated.

Based on this input prompts, an input text (which can be extracted from the prompts) can be preprocessed 23 to ensure compatibility with the LLM. This preprocessing step 23 may involve tokenization, removing irrelevant information, and formatting the text for optimal comprehension by the model. In addition, this process can also incorporate context retrieval for each prompt.

After the input is (pre) processed 23, the step of generating 24 the test script code can be carried out by the fine-tuned (i.e., trained) LLM. Thereby, manufacturer and/or device specific code scripts can be generated, e.g., Python code XLAPI (and/or SCPI commands, CMSequencer building blocks etc.). The LLM can thereby use its understanding of the coding style, conventions, and official specifications of the mobile communication tester and/or its manufacturer to generate a code that is executable by the tester and meets the desired requirements. The generated test script code can provide test routines that comply with the given specifications, e.g. communication standards and test scenario.

The LLM, which can be based on GPT-3.5 architecture, can serve as the base component of the code generation application. The model can be pre-trained on a large corpus of text data and then fine-tuned using the device- or manufacturer-specific code, tutorials, and documentations as described above. Fine-tuning can involve training the model on paired comments and code snippets, optimizing it to generate a Python code that aligns with the coding practices and official specifications of the manufacturer and/or device.

The generated test script code can be returned as an output of the code generation application (step 25). The output can be structured and formatted according to coding standards of the manufacturer and/or the device, ensuring readability and maintainability. The application may also include additional annotations or comments within the generated code to provide explanations or highlight relevant sections. Furthermore, the output can also be further improved by utilizing existing linting and syntax checking applications. This can be done in a postprocessing step 26 as shown in FIG. 2.

The thus generated test script code 27 can be forwarded to the mobile communication tester to carry out the testing routine according to the test scenario.

The test script code generation can be integrated into an existing software development workflow. It can be deployed as a standalone tool or integrated into an IDE as a plug-in or a code generation framework. The integration allows the users to conveniently access the functionality of the application, enhance productivity and ensure adherence to specifications.

To improve the performance and accuracy of the code generation application, an iterative refinement process can be employed. This can involve continuously updating and fine-tuning the LLM using new data, incorporating user feedback, and monitoring the generated code for quality and correctness. The iterative refinement process can ensure that the application evolves alongside the code base and specifications of the manufacturer, maintaining its effectiveness over time.

The LLM-based code generation application described above could further be supplemented by a query functionality, which could be implemented by an AI-powered chatbot that engages in conversations with users and provides code or building blocks for creating test scenarios based on the prompts from a user. The chatbot can combine natural language understanding with code generation capabilities, making it a valuable tool for users, application engineers, developers, and testers. Such a possibility of querying the LLM is shown as an optional step 15 in FIG. 1.

For instance, the chatbot can provide a user-friendly conversational interface where different users (e.g., developers and testers) can interact with the system. Users can communicate with the chatbot using natural language, posing questions, describing test scenarios, or requesting code snippets to fulfill specific requirements.

The chatbot can be trained in vast amounts of software engineering and testing-related data, including documentation, code repositories, best practices, and test scenarios. This can enable the chatbot to possess a broad range of contextual knowledge about software development and testing processes. Additionally, the chatbot can learn from previous interactions and user feedback, allowing it to provide personalized and tailored recommendations to users.

The chatbot can be capable to explain code, and/or to help users to understand the generated code and the underlying principles. For instance, it can provide detailed explanations of the generated code snippets, highlighting the purpose of each section, the logic employed, and how it aligns with the given specifications. By offering code explanations, the chatbot can promote code comprehension and knowledge transfer within the development team.

The chatbot can further act as a valuable assistant. It can analyze the code, identify potential errors or logical flaws, and provide guidance on how to rectify them. The chatbot can leverage contextual knowledge, error analysis techniques, and best practices to assist in resolving issues efficiently and effectively.

To enhance the performance and efficiency of the generated code, the chatbot can further incorporate code optimization techniques. It can analyze code snippets, identify areas for improvement, and provide suggestions for optimizing performance, reducing complexity, or enhancing code readability. The optimization recommendations of the chatbot can be based on industry best practices and can contribute to the overall quality and maintainability of the generated code.

Expanding its capabilities further, the chatbot can automate the generation of test scenarios based on the provided specifications. It can analyze the requirements, codebase, and available resources to automatically generate comprehensive test cases, covering various scenarios and edge cases. The generated tests can be customized, executed, and integrated into the testing framework of choice, reducing manual effort and improving test coverage.

The recommendations and code generation of the chatbot can become increasingly context sensitive as it learns from user interactions and feedback. Over time, it could gain a deeper understanding of the specific requirements, coding patterns, and test scenarios of a certain device manufacturer. This can allow the chatbot to provide more accurate and relevant suggestions, tailored to the unique needs of a group of users and their development practices.

In summary, an application of an AI-powered chatbot for test scenario code generation could extend the capabilities beyond code generation alone. By integrating code explanation, debugging assistance, and optimization techniques, the chatbot can enhance productivity, promote code comprehension, and facilitate efficient software testing. The ability of the chatbot to automate test generation and provide context-sensitive recommendations can further streamline the development process and ensures compliance with evolving specifications and coding standards.

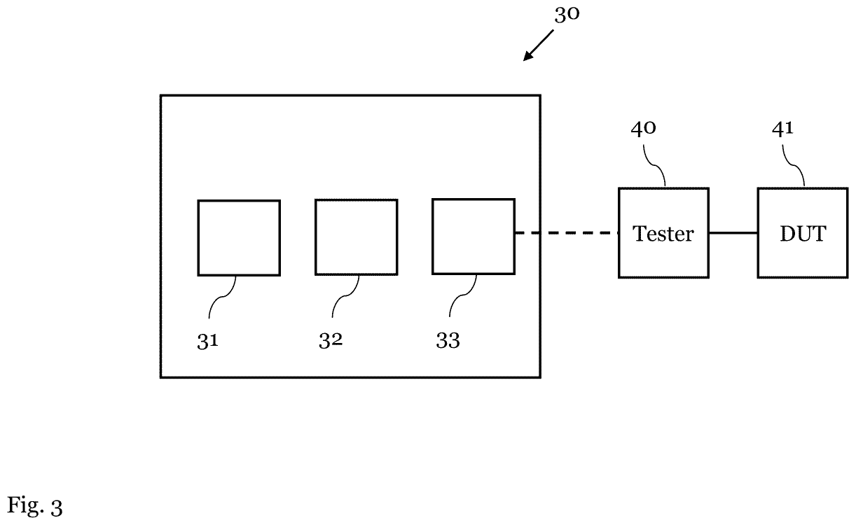

FIG. 3 shows a system 30 for generating code for the mobile communication tester 40 according to an embodiment.

The system 30 comprises: an inputting environment 31 configured to receive the information on a test scenario; and a processor 32 configured to automatically generate the test script code for the mobile communication tester 40 based on the received information, wherein the test script code is configured in such a way that, when it is executed by the mobile communication tester 40, it causes the mobile communication tester 40 to generate the test routine according to the test scenario, wherein the test routine adheres to a mobile communication standard.

The inputting environment 31 can be a communication interface which is configured to receive the information, e.g., in text form. For instance, the inputting environment can comprise a text field in which a user can input the information on the test scenario, and/or the inputting environment can be incorporated in an IDE (integrated development environment).

The system 30 may further comprise an interface 33 configured to output the generated test script code. For instance, the interface 33 can directly be connected to the mobile communication tester 40 or it can indirectly be connected (e.g., via a communication network).

The mobile communication tester 40 can be connected to a mobile device-under-test (DUT) 41. The test routine can be a routine to for testing the DUT 41 and can comprise sending and/or receiving communication signals to respectively from the DUT 41.

The processor 32 can comprise one or more microprocessors. For instance, the processor 32 can be a component of a computing device or a server.

The processor 32 can be configured to execute the trainable large language model (LLM) which generates the test script code.

The processor 32 can be configured to carry out the preprocessing and/or postprocessing of the test script code.

All features of all embodiments described, shown and/or claimed herein can be combined with each other.

1. A method for generating code for a mobile communication tester, comprising the steps of:
receiving information on a test scenario at an inputting environment; and
automatically generating a test script code for the mobile communication tester based on the received information;
wherein the test script code is configured in such a way that, when it is executed by the mobile communication tester, it causes the mobile communication tester to generate a test routine according to the test scenario, wherein the test routine adheres to a mobile communication standard.

2. The method of claim 1,
wherein the test routine comprises a generation and/or a reception of at least one communication signal by the mobile communication tester, wherein the at least one communication signal adheres to the mobile communication standard.

3. The method of claim 1,
wherein the mobile communication standard is a 3GPP based standard.

4. The method of claim 1,
wherein the information on the test scenario is received at the inputting environment in a plain language format.

5. The method of claim 1,
wherein the test script code is generated in Python or a Python based programming language.

6. The method of claim 1, further comprising the step of:
outputting the generated test script code.

7. The method of claim 1, further comprising the step of:
preprocessing and/or postprocessing the test script code.

8. The method of claim 1,
wherein the test script code is generated by a trainable large language model.

9. The method of claim 8,
wherein the large language model is trained by training data, wherein the training data comprises any combination of: instrument documentation of the mobile communication tester, information on communication standards, test specifications, and previously generated test script code.

10. The method of claim 8, further comprising the step of:
receiving a query on the generated test script code;
wherein the large language model is configured to provide information on the test script code based on the query.

11. The method of claim 1, further comprising the step of:
executing the test script code with the mobile communication tester to generate the test routine according to the test scenario.

12. A system for generating code for a mobile communication tester, comprising:
an inputting environment configured to receive information on a test scenario; and
a processor configured to automatically generate a test script code for the mobile communication tester based on the received information,
wherein the test script code is configured in such a way that, when it is executed by the mobile communication tester, it causes the mobile communication tester to generate a test routine according to the test scenario, wherein the test routine adheres to a mobile communication standard.

13. The system of claim 12,
an interface configured to output the generated test script code.

14. The system of claim 12,
wherein the processor is configured to preprocess and/or to postprocess the test script code.

15. The system of claim 12,
wherein the processor is configured to execute a trainable large language model which generates the test script code.
